(19) United States
(12) Patent Application Publication
(10) Pub. No.: US 2019/0294494 A1
(43) Pub. Date: Sep. 26, 2019

(54) VIRTUALIZATION OF STORAGE UNITS IN A DISPERSED STORAGE NETWORK

(71) Applicant: International Business Machines Corporation, Armonk, NY (US)

(72) Inventors: Jason K. Resch, Chicago, IL (US); Vimalkumar P. Gajjar, Roselle, IL (US); S. Christopher Gladwin, Chicago, IL (US); Kumar Abhijeet, Chicago, IL (US)

(21) Appl. No.: 16/440,400

(22) Filed: Jun. 13, 2019

Related U.S. Application Data
(63) Continuation-in-part of application No. 15/804,090, filed on Nov. 6, 2017, now Pat. No. 10,331,519.
Application No. 15/804,090 is a continuation-in-part of application No. 15/427,934, filed on Feb. 8, 2017, now Pat. No. 9,813,501.
Application No. 15/427,934 is a continuation of application No. 13/959,006, filed on Aug. 5, 2013, now Pat. No. 9,648,087.
(60) Provisional application No. 61/711,106, filed on Oct. 8, 2012.

(51) Int. Cl. G06F 11/10; H04L 12/911; G06F 3/06; H04L 29/08; H04L 12/26; G06F 21/64; G06F 9/50

(52) U.S. Cl. CPC G06F 11/108; H04L 47/70; G06F 11/1076; G06F 3/067; G06F 3/064; H04L 67/32; H04L 67/10; H04L 43/0852; H04L 67/1097; G06F 21/64; G06F 9/5027; G06F 3/0619

(57) ABSTRACT

Methods and devices for use in a dispersed storage network (DSN) to emulate storage units. In various examples, a storage unit or other computing device of the DSN receives a set of write slice requests including a set of encoded data slices for storage in the DSN and a set of slice names corresponding to the encoded data slices. The storage unit identifies a set of storage devices for storage of the set of encoded data slices using various described criteria. The identified storage devices include one or more memory devices of the storage unit and one or more temporary memory devices accessible by the storage unit. The storage unit stores the encoded data slices in the identified set of storage devices, generates a set of write slice responses relating to the set of encoded data slices and outputs the set of write slice responses to a requesting entity.

### CROSS-REFERENCE TO RELATED APPLICATIONS

The present U.S. Utility Patent Application claims priority pursuant to 35 U.S.C. § 120, as a continuation-in-part of U.S. Utility patent application Ser. No. 15/804,090, entitled “APPLICATION OF SECRET SHARING SCHEMES AT MULTIPLE LEVELS OF A DISPERSED STORAGE NETWORK,” filed Nov. 6, 2017, pending, which claims priority pursuant to 35 U.S.C. § 120, as a continuation-in-part of U.S. Utility patent application Ser. No. 15/427,934, entitled “ALLOCATING DISTRIBUTED STORAGE AND TASK EXECUTION RESOURCES,” filed Feb. 8, 2017 and now issued as U.S. Pat. No. 9,813,501, which claims priority pursuant to 35 U.S.C. § 120 as a continuation of U.S. Utility application Ser. No. 13/959,006, entitled “ALLOCATING DISTRIBUTED STORAGE AND TASK EXECUTION RESOURCES,” filed Aug. 5, 2013 and now issued as U.S. Pat. No. 9,648,087, which claims priority pursuant to 35 U.S.C. § 119(e) to U.S. Provisional Application No. 61/711,106, entitled “PRIORITIZING TASKS IN A DISTRIBUTED STORAGE AND TASK NETWORK,” filed Oct. 8, 2012, all of which are hereby incorporated herein by reference in their entirety and made part of the present U.S. Utility Patent Application for all purposes.

### BACKGROUND

This invention relates generally to computer networks and, more specifically, to storage and rebuilding of data in a dispersed storage network.

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on a remote storage system. The remote storage system may include a RAID (redundant array of independent disks) system and/or a dispersed storage system that uses an error correction scheme to encode data for storage.

In a RAID system, a RAID controller adds parity data to the original data before storing it across an array of disks. The parity data is calculated from the original data such that the failure of a single disk typically will not result in the loss of the original data. While RAID systems can address certain memory device failures, these systems may suffer from effectiveness, efficiency and security issues. For instance, as more disks are added to the array, the probability of a disk failure rises, which may increase maintenance costs. When a disk fails, for example, it needs to be manually replaced before another disk(s) fails and the data stored in the RAID system is lost. To reduce the risk of data loss, data on a RAID device is often copied to one or more other RAID devices. While this may reduce the possibility of data loss, it also raises security issues since multiple copies of data may be available, thereby increasing the chances of unauthorized access. In addition, co-location of some RAID devices may result in a risk of a complete data loss in the event of a natural disaster, fire, power surge/outage, etc.

### SUMMARY

According to embodiments of the present disclosure, novel methods and systems are presented for use in a dispersed storage network (DSN) to emulate storage units. In various embodiments, a storage unit or other computing device of the DSN receives a set of write slice requests including a set of encoded data slices to be stored in the DSN and a set of slice names corresponding to the set of encoded data slices. The storage unit identifies a set of storage devices for use in storing the set of encoded data slices in a manner that emulates storage in a set of storage units. The set of storage devices include one or more memory devices of the storage unit and one or more temporary memory devices (e.g., detachable memory devices) accessible by the storage unit. The storage unit utilizes the identified set of storage devices for storage of the set of encoded data slices and generates a set of write slice responses (each write slice response including a status indication relating to execution of a corresponding write slice request of the set of write slice requests request) relating to the set of encoded data slices. The storage unit also outputs the set of write slice responses to a requesting entity. In an embodiment, the set of slice names identifies a set of storage units of the DSN, and storing the set of encoded data slices in the identified set of storage devices includes emulating storage of the set of encoded data slices in the set of storage units, in part, by generating the set of write slice responses to include emulated storage unit identifiers. In a further embodiment, at least a decode threshold number of encoded data slices are stored in the one or more memory devices of the storage unit and less than a decode threshold number of encoded data slices are stored in the one or more temporary memory devices. Additional described embodiments include data slice requests and data rebuilding operations involving the encoded data slices as stored in the identified set of storage devices.

### BRIEF DESCRIPTION OF THE DRAWINGS

FIG. 1 is a schematic block diagram of an embodiment of a dispersed or distributed storage network (DSN) in accordance with the present disclosure;

FIG. 2 is a schematic block diagram of an embodiment of a computing core in accordance with the present disclosure;

FIG. 3 is a schematic block diagram of an example of dispersed storage error encoding of data in accordance with the present disclosure;

FIG. 4 is a schematic block diagram of a generic example of an error encoding function in accordance with the present disclosure;

FIG. 5 is a schematic block diagram of a specific example of an error encoding function in accordance with the present disclosure;

FIG. 6 is a schematic block diagram of an example of slice naming information for an encoded data slice (EDS) in accordance with the present disclosure;

FIG. 7 is a schematic block diagram of an example of dispersed storage error decoding of data in accordance with the present disclosure;

FIG. 8 is a schematic block diagram of a generic example of an error decoding function in accordance with the present disclosure;

FIG. 9A is a schematic block diagram of an example of a DSN performing data access operations using storage unit emulation in accordance with an embodiment of the present disclosure;

FIG. 9B is a schematic block diagram of another example of a DSN performing data access operations using storage unit emulation in accordance with an embodiment of the present disclosure;

FIG. 10 is a flowchart illustrating an example of storing data in accordance with an embodiment of the present disclosure;

FIG. 11 is a flowchart illustrating an example of retrieving data in accordance with an embodiment of the present disclosure; and

FIG. 12 is a flowchart illustrating an example of rebuilding data in accordance with an embodiment of the present disclosure.

### DETAILED DESCRIPTION

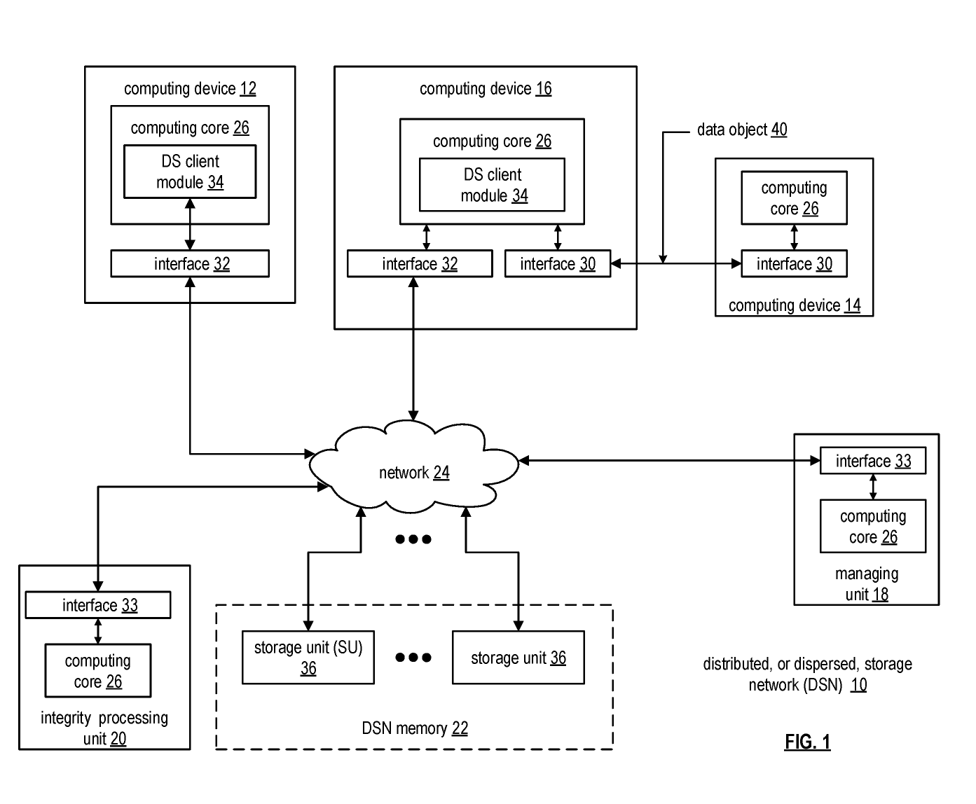

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

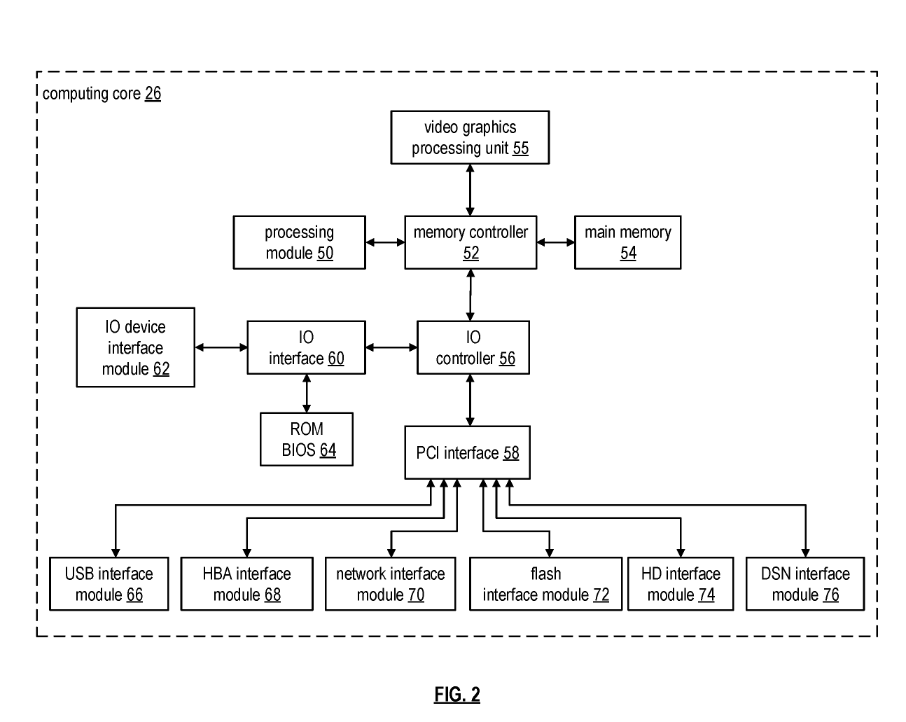

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more than or less than eight storage units 36. Further note that each storage unit 36 includes a computing core (as shown in FIG. 2, or components thereof) and a plurality of memory devices for storing dispersed storage (DS) error encoded data.

Each of the storage units 36 is operable to store DS error encoded data and/or to execute (e.g., in a distributed manner) maintenance tasks and/or data-related tasks. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, maintenance tasks (e.g., rebuilding of data slices, updating hardware, rebooting software, restarting a particular software process, performing an upgrade, installing a software patch, loading a new software revision, performing an off-line test, prioritizing tasks associated with an online test, etc.), etc.

Each of the computing devices 12-16, the managing unit 18, integrity processing unit 20 and (in various embodiments) the storage units 36 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

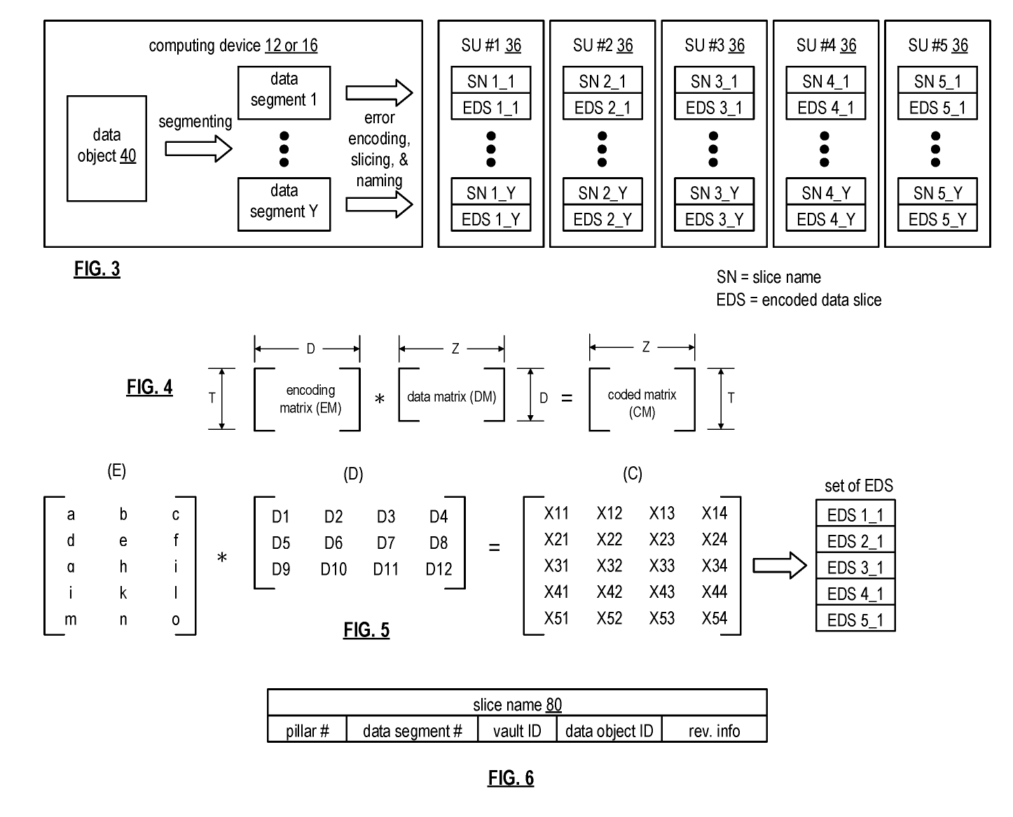

Computing devices 12 and 16 include a dispersed storage (DS) client module 34, which enables the computing device to dispersed storage error encode and decode data (e.g., data object 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate per-access billing information. In another instance, the managing unit 18 tracks the amount of data stored and/or retrieved by a user device and/or a user group, which can be used to generate per-data-amount billing information.

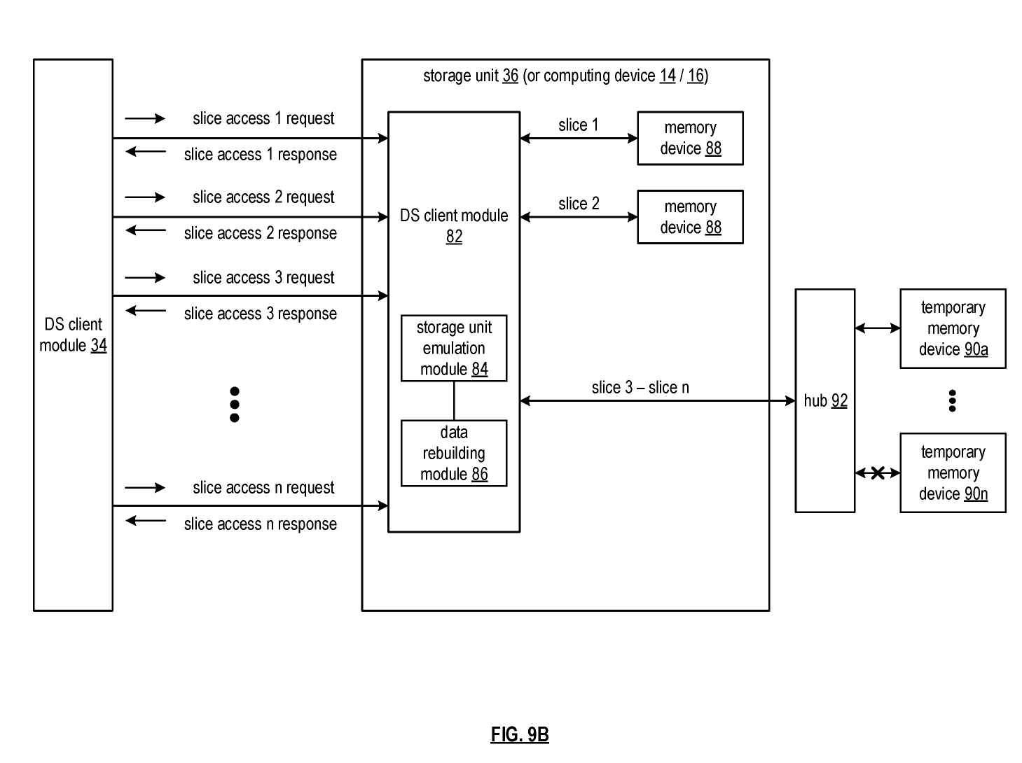

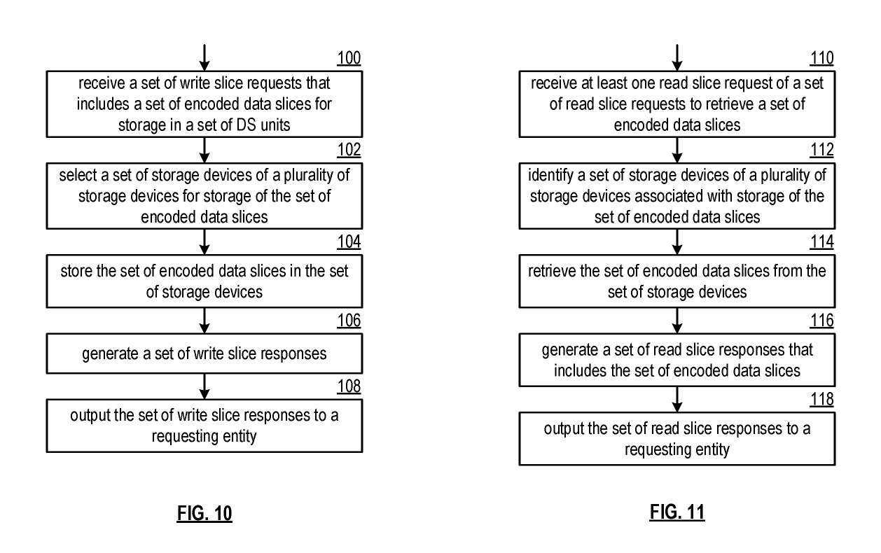

As another example, the managing unit 18 performs network operations, network administration, and/or network maintenance. Network operations includes authenticating user data allocation/access requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10. Examples of data rebuilding operations are discussed in greater detail below with reference to FIGS. 9A-12.

To support data storage integrity verification within the DSN 10, the integrity processing unit 20 (and/or other devices in the DSN 10) may perform rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. Retrieved encoded slices are checked for errors due to data corruption, outdated versioning, etc. If a slice includes an error, it is flagged as a ‘bad’ or ‘corrupt’ slice. Encoded data slices that are not received and/or not listed may be flagged as missing slices. Bad and/or missing slices may be subsequently rebuilt using other retrieved encoded data slices that are deemed to be good slices in order to produce rebuilt slices. A multi-stage decoding process may be employed in certain circumstances to recover data even when the number of valid encoded data slices of a set of encoded data slices is less than a relevant decode threshold number. The rebuilt slices may then be written to DSN memory 22. Note that the integrity processing unit 20 may be a separate unit as shown, included in DSN memory 22, included in the computing device 16, and/or distributed among the storage units 36.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of five, a decode threshold of three, a read threshold of four, and a write threshold of four. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number. In the illustrated example, the value X11=aD1+bD5+cD9, X12=aD2+bD6+cD10, . . . X53=mD3+nD7+oD11, and X54=mD4+nD8+oD12.

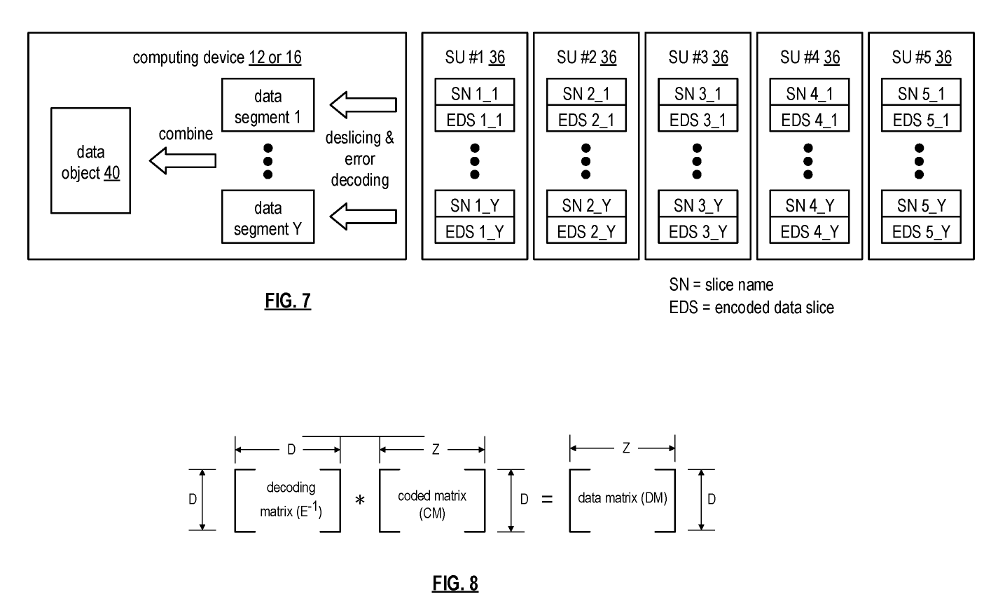

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID) (e.g., mapping to one or more sets of storage units), a data object identifier (ID), and may further include revision level information of the encoded data slices. The slice name functions as at least part of a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

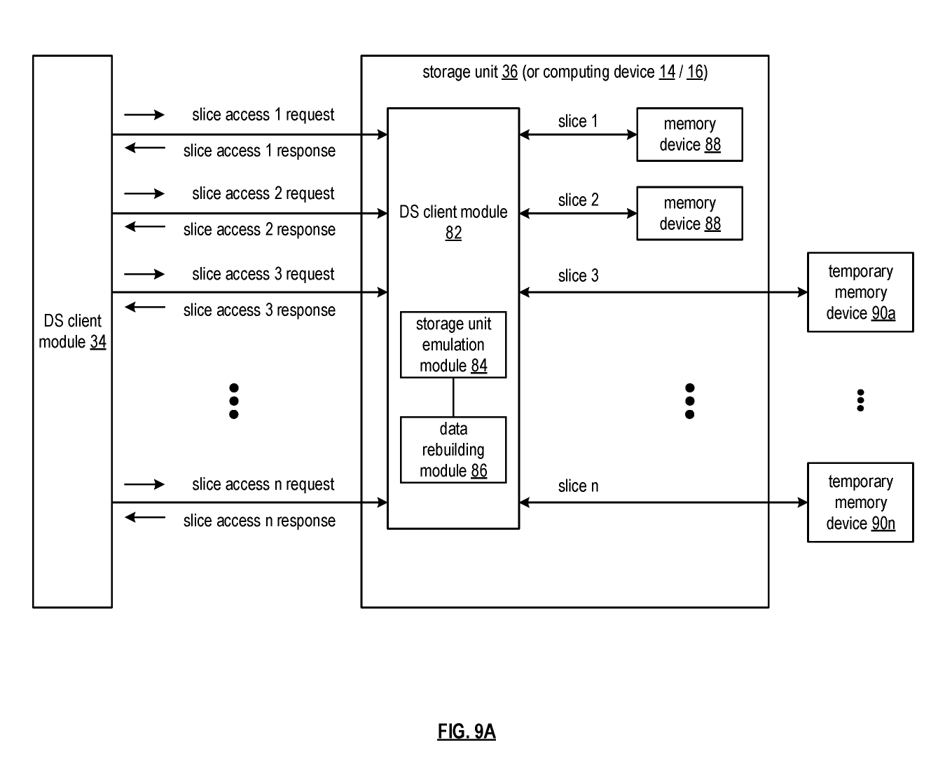

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

In order to recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2 and 4, the encoding matrix is reduced to rows 1, 2 and 4, and then inverted to produce the decoding matrix.

As described more fully below in conjunction with the examples of FIGS. 9A-12, novel systems and methodologies are provided for storing, retrieving and rebuilding data in a dispersed storage network. In various embodiments, the functionality of multiple storage units are emulated by a single storage unit or other computing device of the DSN having multiple available storage devices (e.g., a combination of internal memory devices and attached memory devices) for storage of encoded data slices, thereby improving network flexibility and storage location alternatives. Examples of a dispersed storage network including emulated storage devices are described below in conjunction with the embodiments of FIGS. 9A and 9B. Examples of data storage, retrieval and rebuilding methodologies are described in conjunction with FIGS. 10, 11 and 12, respectively.

Referring now to FIG. 9A, a schematic block diagram of an embodiment of a dispersed storage network (DSN) that includes a distributed storage (DS) client module 34, a storage unit 36 (or other computing device of the DSN), and one or more temporary memory devices 90a-90n is illustrated. In an embodiment, the temporary memory devices 90a-90n accessible by the storage unit 36 may be implemented as one or more of a (detachable) flash drive, an external magnetic disk drive, an external solid state drive, an external optical disk drive, or the like. The storage unit 36 of this example includes a DS client module 82 (e.g., a DS client module 34 such as described above) and one or more memory devices 88. While not separately illustrated in FIG. 9A, the storage unit 36 further includes a processing module and one or more connection interfaces/ports (e.g., USB ports, etc.) for attaching temporary memory devices 90a-90n. Alternatively, the storage unit 36 may be implemented by at least one of a computing device (e.g., computing device 14 or 16), a server, or a user device including a DS client module. In various embodiments, the system functions to access a set of encoded data slices 1-n stored in a set of storage devices in a manner that emulates access involving a set of storage units 36. The storage devices include at least one of the one or more memory devices 88 and may include at least one of the one or more temporary memory devices 90a-90n.

In an example of operation, a data object to be stored in the DSN is segmented to produce a plurality of data segments. The DS client module 34 encodes each data segment using a dispersed storage error coding function in accordance with dispersal parameters to produce a corresponding set of encoded data slices of a plurality of encoded data slices. The plurality of encoded data slices includes the set of encoded data slices. When storing or retrieving the set of encoded data slices, the DS client module 34 generates a set of slice access requests 1-n corresponding to the set of encoded data slices. In an example, the set of slice access requests 1-n includes a set of slice names corresponding to the set of encoded data slices. The set of slice access requests 1-n further includes at least one of a set of read requests or a set of write slice requests. The set of slice access requests 1-n includes the set of encoded data slices when the set of slice access requests 1-n includes a set of write slice requests. In the illustrated embodiment, the DS client module 34 outputs the set of slice access requests 1-n to the storage unit 36.

The DS client module 82 of the storage unit 36 receives the set of slice access requests 1-n and a storage unit emulation module 84 of the DS client module 82 identifies the set of storage devices based on at least one of the set of slice names, a storage device current level of availability indicator, an estimated storage device future level of availability indicator, a storage device performance level indicator, and an estimated access frequency level of the set of encoded data slices. In an example of operation, the storage unit emulation module 84 of the DS client module 82 selects the set of storage devices to include three of temporary memory devices 90a-n and five memory devices 88 when a pillar width number of the dispersal parameters is 8, a decode threshold number of the dispersal parameters is 5, and estimated storage device future level of availability indicators of the three selected temporary memory devices is favorable (e.g., likely to be available when subsequent retrieval of the set of encoded data slices is required) when the set of slice access requests 1-n includes the set of write slice requests.

The DS client module 82 of the storage unit 36 accesses the identified set of storage devices to facilitate the set of slice access requests 1-n. For example, the DS client module 82 of the storage unit 36 stores the set of encoded data slices in the identified set of storage devices when the set of slice access requests 1-n includes the set of write slice requests. As another example, the DS client module 82 of the storage unit 36 retrieves the set of encoded data slices from the identified set of storage devices when the set of slice access requests 1-n includes the set of read slice requests. The DS client module 82 of the storage unit 36 generates a set of slice access responses 1-n to indicate at least one of status (e.g., success, failure, error code) and a result (e.g., a retrieved encoded data slice) of execution of a corresponding slice access request.

In an example of operation of the storage unit 36, emulating storage of the set of encoded data slices in a set of storage units can include, for example, translating or mapping a vault identifier of the set of slice names to addressing information for the identified set of storage devices. In another example wherein the set of slice access requests 1-n include storage unit identification information, emulating storage of the set of encoded data slices in a set of storage units includes translating or mapping the storage unit identification information to addressing information for the identified set of storage units.

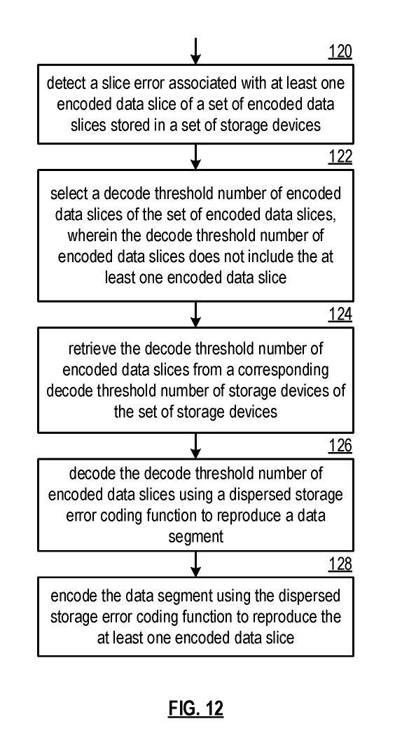

Methods to access the identified set of storage devices for performing write and read requests involving the set of encoded data slices are discussed in greater detail with reference to FIGS. 10-11. In the illustrated embodiment, the DS client module 82 of the storage unit 36 includes a data rebuilding module 86 for performing data rebuilding operations such as described in greater detail with reference to FIG. 12.

FIG. 9B is a schematic block diagram of another example of a DSN performing data access operations using storage unit emulation in accordance with an embodiment of the present disclosure. In the illustrated DSN, access to the temporary memory devices 90a-90n (or a subset thereof) is provided by a hub 92 connected and/or wirelessly coupled to the storage unit 36 via one or more connection interfaces/ports of the storage unit 36. The hub 92 is further coupled a plurality of temporary memory devices 90a-90n. In an example, each temporary memory device 90a-90n may be configured (e.g., by the storage unit emulation module 84) to emulate a differing storage unit of a set of storage units of the DSN. Emulations of the DS client module or modified versions thereof may also be provided (e.g., as implemented by storage unit emulation module 84), providing alternate interfaces to the underlying memory devices.

FIG. 10 is a flowchart illustrating another example of storing data. The method begins at step 100 where a processing module (e.g., of a distributed storage (DS) client module of a storage unit) receives a set of write slice requests that includes a set of encoded data slices for intended storage in a set of storage units. The method continues at step 102 where the processing module selects a set of storage devices. The set of storage devices may include one or more of memory devices and temporary memory devices. The method continues at step 104 where the processing module stores the set of encoded data slices in the set of identified storage devices. The method continues at step 106 where the processing module generates a set of write slice responses. For example, the processing module generates the set of write slice responses to indicate whether a corresponding encoded data slice was successfully stored. The method continues at step 108 where the processing module outputs the set of write slice responses to a requesting entity in accordance with a storage unit emulation approach. The storage unit emulation approach includes at least one of generating a write slice response to include one or more of a write sequence status, a write sequence result, and an emulated storage unit identifier.

FIG. 11 is a flowchart illustrating an example of retrieving data in accordance with an embodiment of the present disclosure. The method begins at step 110 where a processing module (e.g., of a distributed storage (DS) client module of a storage unit) receives at least one read slice request of a set of read slice requests to retrieve a set of encoded data slices (such as a set of encoded data slices stored as described in conjunction with FIG. 10) from a set of storage units. The method continues at step 112 where the processing module identifies a set of storage devices of a plurality of storage devices associated with storage of the set of encoded data slices. The identifying includes at least one of performing a lookup, initiating a query of one or more memory devices, initiating a query of one or more temporary memory devices, and receiving a query response. The method continues at step 114 where the processing module retrieves at least a plurality of encoded data slices, of the set of encoded data slices, from the set of identified storage devices. The method continues at step 116 where the processing module generates a set of read slice responses that includes the set of encoded data slices. The method continues at step 118 where the processing module outputs the set of read slice responses to a requesting entity in accordance with a storage unit emulation approach.

FIG. 12 is a flowchart illustrating an example of rebuilding data in accordance with an embodiment of the present disclosure. The method begins at step 120 where a processing module (e.g., of a distributed storage (DS) client module of a storage unit) detects a slice error associated with at least one encoded data slice of a set of encoded data slices stored in a set of storage devices associated with storage unit emulation. Detecting a slice error includes at least one of identifying a storage device failure associated with the at least one encoded data slice, detecting that a storage device is unavailable (e.g., a temporary memory device is unplugged from the computing device, such as the temporary memory device 90n as illustrated in the example of FIG. 9B), detecting slice corruption, and detecting a missing slice.

The method continues at step 122 where the processing module selects a decode threshold number of encoded data slices of the set of encoded data slices. The decode threshold number of encoded data slices does not include the at least one encoded data slice. Selecting the decode threshold number of encoded data slices includes identifying available encoded data slices stored in available storage devices. The method continues at step 124 where the processing module retrieves the decode threshold number of encoded data slices from a corresponding decode threshold number of storage devices of the set of storage devices. The method continues at step 126 where the processing module decodes the decode threshold number of encoded data slices using a dispersed storage error coding function to reproduce a data segment. The method continues at step 128 where the processing module encodes the data segment using the dispersed storage error coding function to reproduce the at least one encoded data slice. Next, the processing module may store the reproduced at least one encoded data slice in at least one storage device of the set of storage devices.

The methods described above in conjunction with a storage unit 36 and/or computing device 14/16 can alternatively be performed by other modules (e.g., DS client modules 34) of a dispersed storage network or by other devices (e.g., managing unit 18, integrity processing unit 20, etc.). Any combination of a first module, a second module, a third module, a fourth module, etc. of the computing devices and the storage units may perform the method described above. In addition, at least one memory section (e.g., a first memory section, a second memory section, a third memory section, a fourth memory section, a fifth memory section, a sixth memory section, etc. of a non-transitory computer readable storage medium) that stores operational instructions/program instructions can, when executed by one or more processing modules of one or more computing devices and/or by the storage units of the dispersed storage network (DSN), cause the one or more computing devices and/or the storage units to perform any or all of the method steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information as contextually appropriate.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of a computing device of a dispersed storage network (DSN), the method comprises:
receiving, by the computing device of the DSN, a set of write slice requests including a set of encoded data slices to be stored in the DSN and further including a set of slice names corresponding to the set of encoded data slices, wherein at least a decode threshold number of encoded data slices of the set of encoded data slices is required to recover a corresponding data segment;
identifying a set of storage devices of a plurality of storage devices for storage of the set of encoded data slices, wherein the plurality of storage devices includes one or more memory devices of the computing device and one or more temporary memory devices accessible by the computing device;
storing the set of encoded data slices in the identified set of storage devices;
generating, by the computing device, a set of write slice responses relating to the set of encoded data slices; and
outputting the set of write slice responses to a requesting entity.

2. The method of claim 1, wherein identifying a set of storage devices of a plurality of storage devices for storage of the set of encoded data slices is based on at least one of:
a storage device current level of availability indicator relating to one or more storage devices of the plurality of storage devices;
an estimated storage device future level of availability indicator relating to one or more storage devices of the plurality of storage devices;
a storage device performance level indicator relating to one or more storage devices of the plurality of storage devices; or
an estimated access frequency level of the set of encoded data slices.

3. The method of claim 1, wherein the set of slice names identifies a set of storage units of the DSN, and wherein storing the set of encoded data slices in the identified set of storage devices includes emulating storage of the set of encoded data slices in the set of storage units.

4. The method of claim 3, wherein emulating storage of the set of encoded data slices in the set of storage units includes generating the set of write slice responses to include emulated storage unit identifiers.

5. The method of claim 1, wherein each write slice response of the set of write slice responses includes a status indication relating to execution of a corresponding write slice request of the set of write slice requests.

6. The method of claim 1, wherein storing the set of encoded data slices in the identified set of storage devices includes:
storing at least a decode threshold number of encoded data slices in the one or more memory devices of the computing device; and
storing less than the decode threshold number of encoded data slices in the one or more temporary memory devices.

7. The method of claim 1, further comprising:
receiving, by the computing device of the DSN, a set of read slice requests relating to the set of encoded data slices;
identifying a set of storage devices associated with storage of the set of encoded data slices;
retrieving a plurality of encoded data slices, of the set of encoded data slices, from the identified set of storage devices;
generating, by the computing device, a set of read slice responses including the plurality of encoded data slices; and
outputting the set of read slice responses.

8. The method of claim 1, wherein identifying a set of storage devices associated with storage of the set of encoded data slices includes at least one of performing a lookup, initiating a query of one or more memory devices and receiving a query response, or initiating a query of one or more temporary memory devices and receiving a query response.

9. The method of claim 1, further comprising:
detecting a slice error associated with at least one encoded data slice of the set of encoded data slices stored in the identified set of storage devices;
selecting a decode threshold number of encoded data slices of the set of encoded data slices, wherein the decode threshold number of encoded data slices does not include the at least one encoded data slice;
retrieving the decode threshold number of encoded data slices from a corresponding decode threshold number of storage devices of the identified set of storage devices;
decoding the decode threshold number of encoded data slices using a dispersed storage error encoding function to reproduce the corresponding data segment; and
encoding the reproduced data segment using the dispersed storage error encoding function to reproduce the at least one encoded data slice.

10. The method of claim 1, wherein the computing device comprises a storage unit.

11. A storage unit for use in a dispersed storage network (DSN), the storage unit comprises:
a network interface;
at least one connection interface;
a memory comprising instructions; and
one or more processing modules in communication with the network interface, the at least one connection interface, and the memory, wherein the one or more processing modules execute the instructions to:
receive, via the network interface, a set of write slice requests including a set of encoded data slices to be stored in the DSN and further including a set of slice names corresponding to the set of encoded data slices, wherein at least a decode threshold number of encoded data slices of the set of encoded data slices is required to recover a corresponding data segment;
identify a set of storage devices of a plurality of storage devices for storage of the set of encoded data slices, wherein the plurality of storage devices includes one or more memory devices of the storage unit and one or more temporary memory devices accessible by the storage unit via the at least one connection interface;
store the set of encoded data slices in the identified set of storage devices;
generate a set of write slice responses relating to the set of encoded data slices; and
output, via the network interface, the set of write slice responses for receipt by a requesting entity.

12. The storage unit of claim 11, wherein identifying a set of storage devices of a plurality of storage devices for storage of the set of encoded data slices is based on at least one of:
a storage device current level of availability indicator relating to one or more storage devices of the plurality of storage devices;
an estimated storage device future level of availability indicator relating to one or more storage devices of the plurality of storage devices;
a storage device performance level indicator relating to one or more storage devices of the plurality of storage devices; or
an estimated access frequency level of the set of encoded data slices.

13. The storage unit of claim 11, wherein the set of slice names identifies a set of storage units of the DSN, and wherein the set of write slice responses include emulated storage unit identifiers.

14. The storage unit of claim 11, wherein each write slice response of the set of write slice responses includes a status indication relating to execution of a corresponding write slice request of the set of write slice requests.

15. The storage unit of claim 11, wherein storing the set of encoded data slices in the identified set of storage devices includes:
storing at least a decode threshold number of encoded data slices in the one or more memory devices of the storage unit; and
storing less than the decode threshold number of encoded data slices in the one or more temporary memory devices.

16. The storage unit of claim 11, wherein the one or more processing modules further execute the instructions to:
receive, via the network interface, a set of read slice requests relating to the set of encoded data slices;
identify a set of storage devices associated with storage of the set of encoded data slices;
retrieve a plurality of encoded data slices, of the set of encoded data slices, from the identified set of storage devices;
generate a set of read slice responses including the plurality of encoded data slices; and
output, via the network interface, the set of read slice responses.

17. The storage unit of claim 11, wherein the one or more processing modules further execute the instructions to:
detect a slice error associated with at least one encoded data slice of the set of encoded data slices stored in the identified set of storage devices;
select a decode threshold number of encoded data slices of the set of encoded data slices, wherein the decode threshold number of encoded data slices does not include the at least one encoded data slice;
retrieve the decode threshold number of encoded data slices from a corresponding decode threshold number of storage devices of the identified set of storage devices;
decode the decode threshold number of encoded data slices using a dispersed storage error encoding function to reproduce the corresponding data segment;
encode the reproduced data segment using the dispersed storage error encoding function to reproduce the at least one encoded data slice; and
store the reproduced at least one encoded data slice in at least one storage device of the plurality of storage devices.

18. A non-transitory computer readable storage medium comprises:
at least one memory section that stores operational instructions that, when executed by one or more processing modules of a storage unit of a dispersed storage network (DSN), causes the one or more processing modules to:
receive a set of write slice requests including a set of encoded data slices to be stored in the DSN and further including a set of slice names corresponding to the set of encoded data slices, wherein at least a decode threshold number of encoded data slices of the set of encoded data slices is required to recover a corresponding data segment;
identify a set of storage devices of a plurality of storage devices for storage of the set of encoded data slices, wherein the plurality of storage devices includes one or more memory devices of the storage unit and one or more temporary memory devices accessible by the storage unit;
store the set of encoded data slices in the identified set of storage devices;
generate a set of write slice responses relating to the set of encoded data slices; and
output the set of write slice responses for receipt by a requesting entity.

19. The non-transitory computer readable storage medium of claim 18, wherein the at least one memory section stores further operational instructions that, when executed by the one or more processing modules of the storage unit, causes the one or more processing modules to:
receive a set of read slice requests relating to the set of encoded data slices;
identify a set of storage devices associated with storage of the set of encoded data slices;
retrieve a plurality of encoded data slices, of the set of encoded data slices, from the identified set of storage devices;
generate a set of read slice responses including the plurality of encoded data slices; and
output the set of read slice responses.

20. The non-transitory computer readable storage medium of claim 18, wherein the at least one memory section stores further operational instructions that, when executed by the one or more processing modules of the storage unit, causes the one or more processing modules to:
detect a slice error associated with at least one encoded data slice of the set of encoded data slices stored in the identified set of storage devices;
select a decode threshold number of encoded data slices of the set of encoded data slices, wherein the decode threshold number of encoded data slices does not include the at least one encoded data slice;
retrieve the decode threshold number of encoded data slices from a corresponding decode threshold number of storage devices of the identified set of storage devices;
decode the decode threshold number of encoded data slices using a dispersed storage error encoding function to reproduce the corresponding data segment;
encode the reproduced data segment using the dispersed storage error encoding function to reproduce the at least one encoded data slice; and
store the reproduced at least one encoded data slice in at least one storage device of the plurality of storage devices.
